(19) United States
(12) Patent Application Publication
(10) Pub. No.: US 2026/0169318 A1
(43) Pub. Date: Jun. 18, 2026

(54) OPTICAL MODULATOR AND OPTICAL DEVICE INCLUDING THE SAME

(71) Applicant: SAMSUNG ELECTRONICS CO., LTD., Suwon-si (KR)

(72) Inventor: Duhyun LEE, Suwon-si (KR)

(73) Assignee: SAMSUNG ELECTRONICS CO., LTD., Suwon-si (KR)

(21) Appl. No.: 19/295,831

(22) Filed: Aug. 11, 2025

(30) Foreign Application Priority Data
Dec. 18, 2024 (KR) 10-2024-0190446

(51) Int. Cl. G02F 1/025; G02F 1/01

(52) U.S. Cl. CPC G02F 1/025; G02F 1/0147; G02F 2201/063

(57) ABSTRACT

Provided is an optical modulator including a first optical waveguide having a ring shape; and a second optical waveguide having a U shape extending adjacent to opposite sides of the first optical waveguide, the second optical waveguide including a first modulation unit and a second modulation unit, wherein the first optical waveguide and the second optical waveguide are coupled to each other at a first coupling region and a second coupling region.

### CROSS-REFERENCE TO RELATED APPLICATION

This application is based on and claims priority under 35 U.S.C. §119 to Korean Patent Application No. 10-2024-0190446, filed on Dec. 18, 2024, in the Korean Intellectual Property Office, the disclosure of which is incorporated by reference herein in its entirety.

### BACKGROUND

### 1. Field

The disclosure relates to an optical modulator and an optical device including the same.

### 2. Description of the Related Art

Optical modulators such as Mach-Zehnder interferometers (MZIs) or micro-ring modulators (MRMs) are used in silicon (Si)-based photonic integrated circuits (PICs).

For broadband information transmission, approaches have been made to increase the modulation speed of optical modulators, and at the same time, for parallel processing, wavelength division multiplexing (WDM) technology has been used to simultaneously transmit signals of multiple wavelengths through a single waveguide.

MRMs, which perform high-speed modulation functions, are widely used because they may have relatively simple configuration of WDM optical circuits by modulating only light of a wavelength that matches a resonance wavelength of a micro-ring and enable high-speed modulation. In particular, pulse amplitude modulation (PAM) has been used for MRMs to increase transmission density.

### SUMMARY

Provided is an optical modulator capable of converting a digital electric signal into an analog optical signal without digital-to-analog (D/A) conversion.

Additional aspects will be set forth in part in the description which follows and, in part, will be apparent from the description, or may be learned by practice of embodiments of the disclosure.

According to an aspect of the disclosure, an optical modulator includes: a first optical waveguide having a ring shape; and a second optical waveguide having a U shape extending adjacent to opposite sides of the first optical waveguide, the second optical waveguide including a first modulation unit and a second modulation unit, wherein the first optical waveguide and the second optical waveguide are coupled to each other at a first coupling region and a second coupling region.

A length of the first modulation unit may be greater than a length of the second modulation unit.

A length of the first modulation unit may be twice a length of the second modulation unit.

A length of a first optical path including an entirety of the first optical waveguide may be an integer multiple of a wavelength of light to be modulated.

A length of a second optical path may be an integer multiple of a length of a first optical path, the first optical path includes an entirety of the first optical waveguide, and the second optical path includes a portion of the first optical waveguide extending from the first coupling region to the second coupling region, and a portion of the second optical waveguide extending from the portion of the first optical waveguide at the first coupling region to the portion of the first optical waveguide at the second coupling region.

The first modulation unit includes a first region and a second region which are respectively doped with opposite types of dopants.

The first region may be doped with an n-type dopant, and the second region may be doped with a p-type dopant.

A width of the first region may be less than a width of the second region.

The first modulation unit further includes: a third region doped at a concentration greater than a concentration of the first region; and a fourth region doped at a concentration greater than a concentration of the second region.

The third region may be doped with an n-type dopant, and the fourth region may be doped with a p-type dopant.

The optical modulator may further include a first electrode on the third region; and a second electrode on the fourth region.

The first electrode may be a cathode, and the second electrode may be an anode.

The optical modulator may further include a first heater on the first optical waveguide.

The optical modulator may include a second heater on the second optical waveguide.

A distance between the first optical waveguide and the second optical waveguide in each of the first coupling region and the second coupling region may be greater than or equal to 100 nm and less than or equal to 200 nm.

A width of the second optical waveguide may be greater than or equal to 100 nm and less than or equal to 500 nm.

According to an aspect of the disclosure, an optical modulator includes: a substrate; a first optical waveguide having a ring shape on the substrate; and a second optical waveguide having a U shape extending adjacent to opposite sides of the first optical waveguide, the second optical waveguide including a first modulation unit, a second modulation unit, and a third modulation unit, wherein the first optical waveguide and the second optical waveguide are coupled to each other at a first coupling region and a second coupling region.

A length of a first optical path including an entirety of the first optical waveguide may be an integer multiple of a wavelength of light to be modulated.

A length of a second optical path is an integer multiple of a length of a first optical path, the first optical path comprises an entirety of the first optical waveguide, and the second optical path comprises a portion of the first optical waveguide extending from the first coupling region to the second coupling region, and a portion of the second optical waveguide extending from the portion of the first optical waveguide at the first coupling region to the portion of the first optical waveguide at the second coupling region.

According to an aspect of the disclosure, an optical device includes an optical modulator including: a first optical waveguide having a ring shape; and a second optical waveguide having a U shape extending adjacent to opposite sides of the first optical waveguide, the second optical waveguide including a first modulation unit and a second modulation unit, wherein the first optical waveguide and the second optical waveguide are coupled to each other at a first coupling region and a second coupling region.

### BRIEF DESCRIPTION OF DRAWINGS

The above and other aspects, features, and advantages of one or more embodiments will be more apparent from the following description taken in conjunction with the accompanying drawings, in which:

FIG. 1 shows an optical modulator according to one or more embodiments;

FIG. 2 is a cross-sectional view along a line A-A′ of FIG. 1;

FIG. 3 is a cross-sectional view along a line B-B′ of FIG. 1;

FIGS. 4A and 4B show an optical path according to one or more embodiments;

FIG. 5 shows an optical modulator according to one or more embodiments;

FIG. 6 shows an optical modulator according to one or more embodiments;

FIG. 7 shows an optical modulator according to one or more embodiments;

FIG. 8 shows a relationship between a length of a first optical path and a length of a second path described with reference to FIGS. 4A and 4B;

FIGS. 9 and 10 are graphs showing a transmissivity spectrum of an optical modulator according to one or more embodiments;

FIG. 11 is a graph showing an interval of a signal level with respect to a length of a first modulator and a length of a second modulator;

FIG. 12 is a block diagram of an optical device according to one or more embodiments;

FIGS. 13 and 14 are conceptual views showing a vehicle including a light detection and ranging (LiDAR) device according to one or more embodiments; and

FIG. 15 shows an optical transmitter according to one or more embodiments.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, with reference to the accompanying drawings, an optical integrated circuit and a method of manufacturing the same according to various embodiments will be described in detail. In the drawings, like reference numerals denote like components, and sizes of components in the drawings may be exaggerated for convenience of explanation. In addition, embodiments to be described are merely examples, and various modifications may be made from such embodiments.

An expression such as “above” or “on” may include not only the meaning of “immediately on in a contact manner”, but also the meaning of “on in a non-contact manner”. Singular forms include plural forms unless apparently indicated otherwise contextually. In case that a portion is referred to as “comprises” a component, the portion may not exclude another component but may further include another component unless stated otherwise.

The use of the terms of “the above-described” and similar indicative terms may correspond to both the singular forms and the plural forms. The use of the terms of “the above-described” and similar indicative terms may correspond to both the singular forms and the plural forms.

Connections of lines or connection members between components shown in the drawings are illustrative of functional connections and/or physical or circuit connections, and in practice, may be represented as alternative or additional various functional connections, physical connections, or circuit connections.

The use of all examples or exemplary terms is only to describe technical spirit in detail, and the scope is not limited by these examples or terms unless limited by the claims.

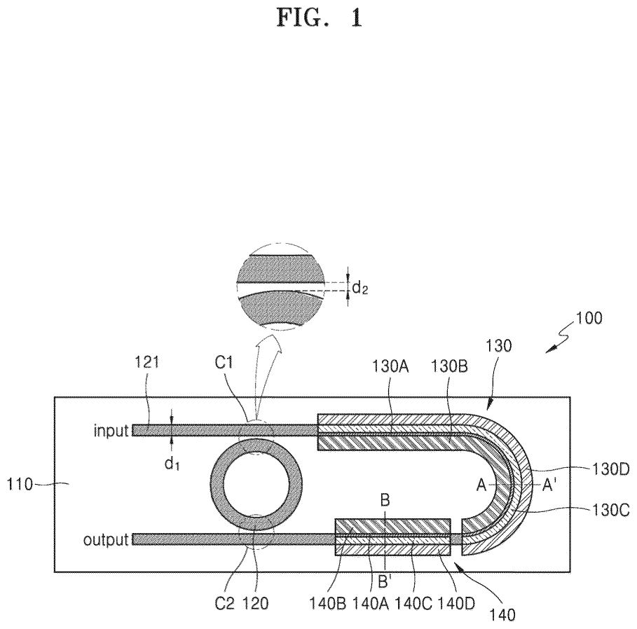

FIG. 1 shows an optical modulator according to an embodiment.

Referring to FIG. 1, an optical modulator 100 may include a substrate 110, a first optical waveguide 120 provided in a ring shape or a closed curve shape on the substrate 110, and a second optical waveguide 121 provided in a U shape around the first optical waveguide 120. That is, the U shape of the second optical waveguide 121 may be formed by a semicircular-shape portion and two substantially straight portions extending adjacent to opposite sides of the first optical waveguide 120 from ends of the semicircular-shape portion. The second optical waveguide 121 may include a first modulation unit (first modulator) 130 and a second modulation unit (second modulator) 140.

The substrate 110 may include, for example, silicon (Si). However, a material of the substrate 110 is not necessarily limited to Si, and various wafer materials used in semiconductor manufacturing processes may be used for the substrate 110.

The first optical waveguide 120 may be provided in a closed curve shape or a ring shape having a specific width. The width of the first optical waveguide 120 may be greater than or equal to 100 nm and less than or equal to 500 nm. The first optical waveguide 120 may include Si.

The second optical waveguide 121 may be provided adjacent to and around the first optical waveguide 120. The second optical waveguide 121 may include one input terminal INPUT through which light is incident and one output terminal OUTPUT through which incident light is output to outside. A width d₁ of the second optical waveguide 121 may be greater than or equal to 100 nm and less than or equal to 500 nm. The second optical waveguide 121 may include Si. The second optical waveguide 121 may include, for example, a rib waveguide or a strip waveguide having a pattern partially etched in a thickness direction, but may also have various shapes without being limited thereto.

The first modulation unit 130 and the second modulation unit 140 included in the second optical waveguide 121 may have different lengths. The length of the first modulation unit 130 may be greater than the length of the second modulation unit 140. The length of the first modulation unit 130 may be, for example, twice that of the second modulation unit 140.

The first modulation unit 130 and the second modulation unit 140 each may manage unique bits of a 2-bit input signal. The first modulation unit 130 may modulate a signal having the greater one between the 2 bits, and the second modulation unit 140 may modulate a signal having the lesser one between the 2 bits. For example, a digital signal corresponding to a most significant bit (MSB) may be input to the first modulation unit 130 and a digital signal corresponding to a least significant bit (LSB) may be input to the second modulation unit 140, and through a combination of modulation amounts made by the first modulation unit 130 and the second modulation unit 140, optical modulation of 4 levels may be implemented.

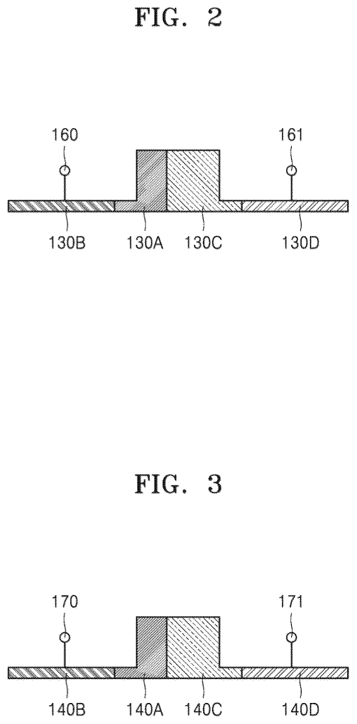

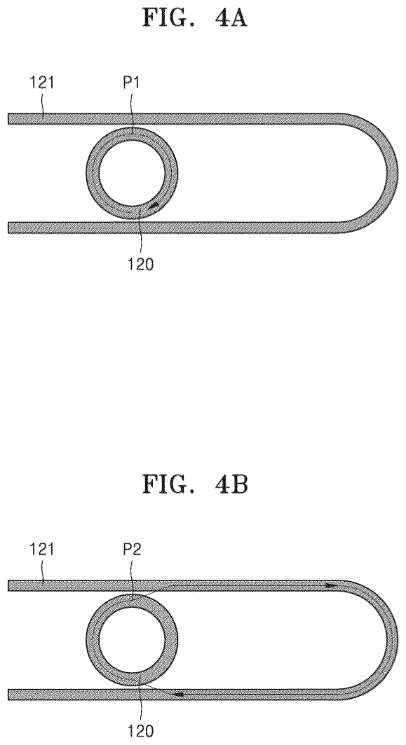

The first modulation unit 130 and the second modulation unit 140 may be formed by doping the second optical waveguide 121 with a dopant. A detailed description of the first modulation unit 130 and the second modulation unit 140 will be made later with reference to FIGS. 2 and 3.

The first optical waveguide 120 and the second optical waveguide 121 may be coupled to each other through two coupling regions C1 and C2. Accordingly, the first optical waveguide 120 and the second optical waveguide 121 may operate as resonators.

At the two coupling regions C1 and C2, the first optical waveguide 120 and the second optical waveguide 121 may be spaced apart from each other by a specific distance. A distance d₂ between the first optical waveguide 120 and the second optical waveguide 121 may be referred to as a coupling gap. The distance d₂ between the first optical waveguide 120 and the second optical waveguide 121 may be greater than or equal to 100 nm and less than or equal to 200 nm.

According to one or more embodiments, the second optical waveguide 121 provided in a U shape may include the first modulation unit 130 and the second modulation unit 140, thereby implementing optical modulation of 4 levels.

FIG. 2 is a cross-sectional view along a line A-A′ of FIG. 1.

Referring to FIG. 2, the first modulation unit 130 may include a plurality of different regions having different dopants and/or doping concentrations.

The first modulation unit 130 may include a first region 130A and a second region 130C which are doped with opposite-type dopants. For example, the first region 130A may be doped with an n-type dopant, and the second region 130C may be doped with a p-type dopant. The first region 130A may be doped with, for example, phosphorus (P) or arsenic (As), and the second region 130C may be doped with, for example, boron (B) or indium (In). As a change in holes contributes more effectively to a change in the characteristics of light, the width of the first region 130A doped with the n-type dopant may be less than the width of the second region 130C doped with the p-type dopant.

The first modulation unit 130 may further include a third region 130B doped at a higher concentration than a concentration of the first region 130A and a fourth region 130D doped at a higher concentration than a concentration of the second region 130C. For example, the third region 130B may be doped with the n-type dopant, and the fourth region 130D may be doped with the p-type dopant. The third region 130B may be doped with, for example, P or As, and the fourth region 130D may be doped with, for example, B or In.

The optical modulator 100 may further include a first electrode 160 provided on and facing the third region 130B of the first modulation unit 130 and a second electrode 161 provided on and facing the fourth region 130D of the first modulation unit 130. The first electrode 160 may be a cathode, and the second electrode 161 may be an anode. The first electrode 160 and the second electrode 161 may include, but not limited to, metals or an alloy that may be used as an electrode material.

FIG. 3 is a cross-sectional view along a line B-B′ of FIG. 1.

Referring to FIG. 3, the second modulation unit 140 may include a plurality of different regions having different dopants and/or doping concentrations.

The second modulation unit 140 may include a first region 140A and a second region 140C which are doped with opposite-type dopants. For example, the first region 140A may be doped with the n-type dopant, and the second region 140C may be doped with the p-type dopant. The first region 140A may be doped with, for example, P or As, and the second region 140C may be doped with, for example, B or In. As a change in holes contributes more effectively to a change in the characteristics of light, the width of the first region 140A doped with the n-type dopant may be less than the width of the second region 140C doped with the p-type dopant.

The second modulation unit 140 may further include a third region 140B doped at a higher concentration than a concentration of the first region 140A and a fourth region 140D doped at a higher concentration than a concentration of the second region 140C. For example, the third region 140B may be doped with the n-type dopant, and the fourth region 140D may be doped with the p-type dopant. The third region 140B may be doped with, for example, P or As, and the fourth region 140D may be doped with, for example, B or In.

The optical modulator 100 may further include a first electrode 170 provided on and facing the third region 140B of the second modulation unit 140 and a second electrode 171 provided on and facing the fourth region 140D. The first electrode 170 may be a cathode, and the second electrode 171 may be an anode. The second electrode 170 and the second electrode 171 may include, but not limited to, metals or an alloy that may be used as an electrode material.

The optical modulator 100 according to one or more embodiments may implement optical modulation of four levels through a combination of modulation amounts made by the first modulation unit 130 and the second modulation unit 140. The optical modulator according to one or more embodiments may include a modulation unit on a bus waveguide in a U shape to reduce a process difficulty.

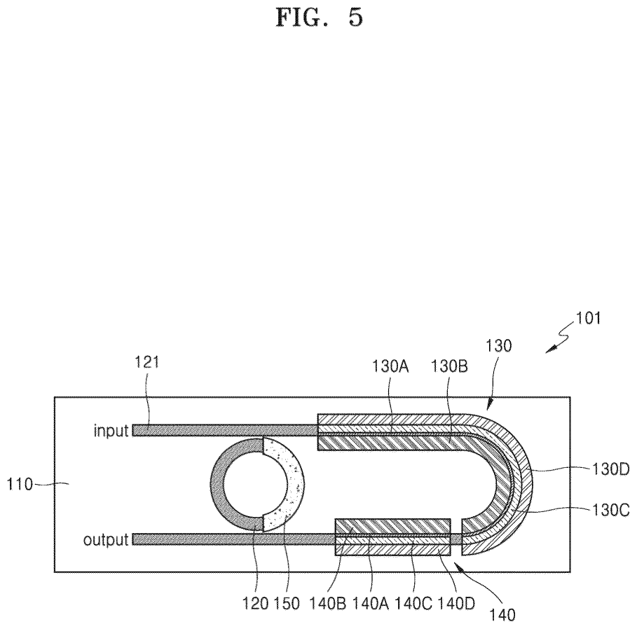

FIGS. 4A and 4B show an optical path according to one or more embodiments.

Referring to FIG. 4A, a first optical path P1 may include the entire first optical waveguide 120. Light incident through the input terminal INPUT of the second optical waveguide 121 may be incident to the first optical waveguide 120 through the first coupling region C1 of FIG. 1, circulate along the first optical path P1, be incident to the second optical waveguide 121 through the second coupling region C2 of FIG. 1, and be output to outside through the output terminal OUTPUT.

Referring to FIG. 4B, a second optical path P2 may include a portion of the first optical waveguide 120 extending from the second coupling region C2 to the first coupling region C1, and a portion of the second optical waveguide 121 extending from the portion of the first optical waveguide 120 at the first coupling region C1 to the portion of the first optical waveguide 120 at the second coupling region C2. That is, the second optical path P2 extends along the portion of the first optical waveguide 120 and extends in a U shape around a portion opposite to the portion of the first optical waveguide 120.

To match a phase of resonance through the first optical path P1 to a phase of resonance through the second optical path P2, a length of the first optical path P1 and a length of the second optical path P2 may be adjusted. The length of the second optical path P2 may be an integer multiple of the length of the first optical path P1. The length of the first optical path P1 may be an integer multiple of a wavelength of light to be modulated. The length of the second optical path P2 may be an integer multiple of a wavelength of light to be modulated.

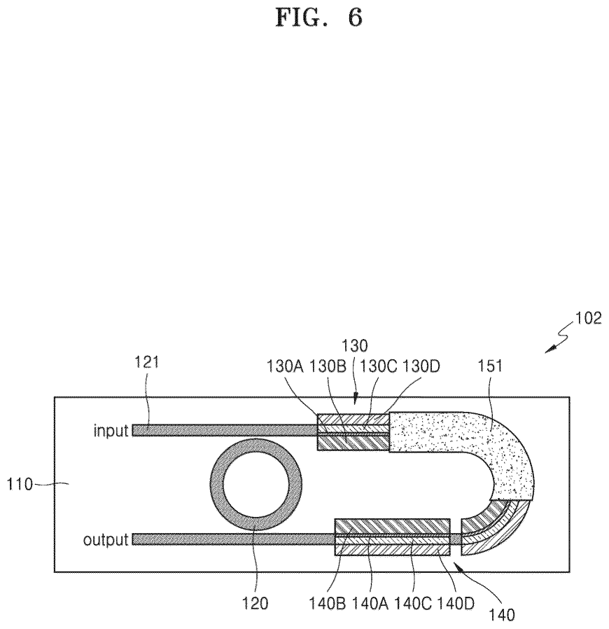

FIG. 5 shows an optical modulator according to one or more embodiments.

The optical modulator 101 may be the same as the optical modulator 100 of FIG. 1 except for further including the first heater 150. In the description of FIG. 5, subject matter overlapping that of FIG. 1 will be omitted.

Referring to FIG. 5, an optical modulator 101 may include the substrate 110, the first optical waveguide 120 provided in a ring shape on the substrate 110, the second optical waveguide 121 provided in a U shape adjacent to and around the first optical waveguide 120 and including the first modulation unit 130 and the second modulation unit 140, and a first heater 150.

The first heater 150 may be provided on the first optical waveguide 120. The first heater 150 may be provided in contact with the first optical waveguide 120. However, without being limited thereto, the first heater 150 may be spaced apart from the first optical waveguide 120 with a specific distance therebetween. The first heater 150 may overlap a portion of the first optical waveguide 120 in perpendicular to the substrate 110. The first heater 150 may finely adjust the wavelength of light. The first heater 150 may include a metal material. The first heater 150 may include, for example, titanium nitride (TiN), tungsten (W), or Si.

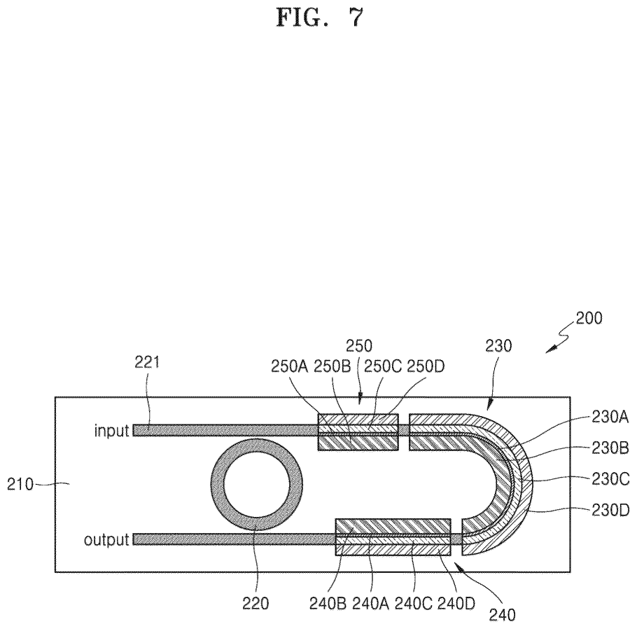

FIG. 6 shows an optical modulator according to one or more embodiments.

The optical modulator 102 may be the same as the optical modulator 100 of FIG. 1 except for further including the second heater 151. In a description of FIG. 6, a matter overlapping that of FIG. 1 will be omitted.

Referring to FIG. 6, an optical modulator 102 may include the substrate 110, the first optical waveguide 120 provided in a ring shape on the substrate 110, the second optical waveguide 121 provided in a U shape adjacent to and around the first optical waveguide 120 and including the first modulation unit 130 and the second modulation unit 140, and a second heater 151.

The second heater 151 may be provided on the second optical waveguide 121. The second heater 151 may be provided in contact with the second optical waveguide 121. However, without being limited thereto, the second heater 151 may be spaced apart from the second optical waveguide 121 with a specific distance therebetween. The second heater 151 may overlap a portion of the second optical waveguide 121 in perpendicular to the substrate 110. The second heater 151 may be provided on the first modulation unit 130. The second heater 151 may overlap a portion of the first modulation unit 130 in perpendicular to the substrate 110.

FIG. 6 illustrates that the second heater 151 is provided on the first modulation unit 130, and the second heater 151 may also be provided on the second modulation unit 140. For example, the second heater 151 may overlap a portion of the second modulation unit 140 in perpendicular to the substrate 110.

The second heater 151 may more finely adjust the wavelength of light. The second heater 151 may include a metal material. The second heater 151 may include, for example, TiN, W, or Si.

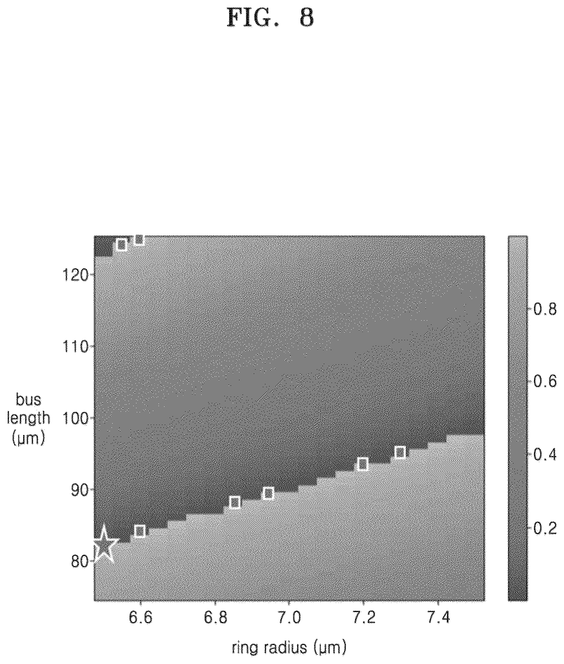

FIG. 7 shows an optical modulator according to one or more embodiments.

Referring to FIG. 7, an optical modulator 200 may include a substrate 210, a first optical waveguide 220 provided in a ring shape on the substrate 210, and a second optical waveguide 221 provided in a U shape adjacent to and around the first optical waveguide 220 and including a first modulation unit 230, a second modulation unit 240, and a third modulation unit 250. The substrate 210 and the first optical waveguide 220 may be the same as the substrate 110 and the first optical waveguide 120 of FIG. 1.

The second optical waveguide 221 may include the first modulation unit 230, the second modulation unit 240, and the third modulation unit 250 which have different lengths. For example, the length of the first modulation unit 230 may be greater than the length of the second modulation unit 240, and the length of the second modulation unit 240 may be greater than the length of the third modulation unit 250.

The first modulation unit 230, the second modulation unit 240, and the third modulation unit 250 each may modulate unique bits of a three-bit input signal. The longest first modulation unit 230 may modulate the greatest signal among the three bits, and the shortest third modulation unit 250 may modulate the smallest signal among the three bits. That is, a digital signal corresponding to an MSB may be input to the first modulation unit 230 and a digital signal corresponding to an LSB may be input to the third modulation unit 250, and through a combination of modulation amounts made by the first modulation unit 230, the second modulation unit 240, and the third modulation unit 250, optical modulation of 8 levels may be implemented.

The first modulation unit 230, the second modulation unit 240, and the third modulation unit 250 may be formed by doping the second optical waveguide 221 with a dopant.

The first modulation unit 230 may include a first region 230A and a second region 230C which are doped with opposite-type dopants. For example, the first region 230A may be doped with the n-type dopant, and the second region 230C may be doped with the p-type dopant. The first region 230A may be doped with, for example, P or As, and the second region 230C may be doped with, for example, B or In. As a change in holes contributes more effectively to a change in the characteristics of light, the width of the first region 230A doped with the n-type dopant may be less than the width of the second region 230C doped with the p-type dopant.

The first modulation unit 230 may further include a third region 230B doped at a higher concentration than a concentration of the first region 230A and a fourth region 230D doped at a higher concentration than a concentration of the second region 230C. For example, the third region 230B may be doped with the n-type dopant, and the fourth region 230D may be doped with the p-type dopant. The third region 230B may be doped with, for example, P or As, and the fourth region 230D may be doped with, for example, B or In.

The second modulation unit 240 may include a first region 240A and a second region 240C which are doped with opposite-type dopants. For example, the first region 240A may be doped with the n-type dopant, and the second region 240C may be doped with the p-type dopant. The first region 240A may be doped with, for example, P or As, and the second region 240C may be doped with, for example, B or In. As a change in holes contributes more effectively to a change in the characteristics of light, the width of the first region 240A doped with the n-type dopant may be less than the width of the second region 240C doped with the p-type dopant.

The second modulation unit 240 may further include a third region 240B doped at a higher concentration than a concentration of the first region 240A and a fourth region 240D doped at a higher concentration than a concentration of the second region 240C. The third region 240B may be doped with the n-type dopant, and the fourth region 240D may be doped with the p-type dopant. The third region 240B may be doped with, for example, P or As, and the fourth region 240D may be doped with, for example, B or In.

The third modulation unit 250 may include a first region 250A and a second region 250C which are doped with opposite-type dopants. For example, the first region 250A may be doped with the n-type dopant, and the second region 250C may be doped with the p-type dopant. The first region 250A may be doped with, for example, P or As, and the second region 250C may be doped with, for example, B or In. As a change in holes contributes more effectively to a change in the characteristics of light, the width of the first region 250A doped with the n-type dopant may be less than the width of the second region 250C doped with the p-type dopant.

The third modulation unit 250 may further include a third region 250B doped at a higher concentration than a concentration of the first region 250A and a fourth region 250D doped at a higher concentration than a concentration of the second region 250C. For example, the third region 250B may be doped with the n-type dopant, and the fourth region 250D may be doped with the p-type dopant. The third region 250B may be doped with, for example, P or As, and the fourth region 250D may be doped with, for example, B or In.

The optical modulator 200 may further include a first electrode provided on and facing the third regions 230B, 240B, and 250B of the modulation units 230, 240, and 250, and a second electrode provided on and facing the fourth regions 230D, 240D, and 250D.

The optical modulator 200 according to one or more embodiments may implement optical modulation of 8 levels through a combination of modulation amounts made by the first according to one or more embodiments 230, the second modulation unit 240, and the third modulation unit 250.

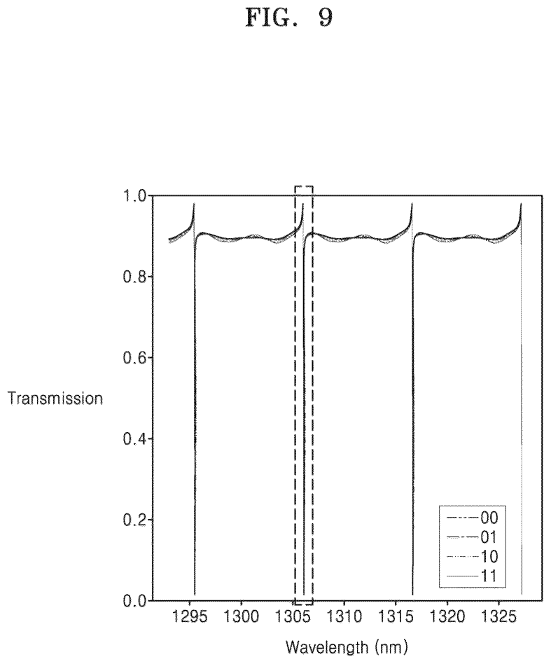

FIG. 8 shows a relationship between a length of a first optical path and a length of a second path, described with reference to FIGS. 4A and 4B.

Referring to FIG. 8, an x axis indicates a radius of the first optical waveguide 120 of FIG. 4A forming the first optical path P1 of FIG. 4A, and a y axis indicates a length of the second optical path P2 of FIG. 4B.

At 1 in a bar graph on the right, a phase of resonance of the first optical path P1 of FIG. 4A and a phase of resonance of the second optical path P2 of FIG. 4B match each other. For example, in the bar graph on the right, as a value is closer to 1, a resonator may operate closer to an idea resonator. When the length of the second optical path P2 of FIG. 4B is twice or three times the length of the first optical path P1 of FIG. 4A, the phase of resonance of the first optical path P1 of FIG. 4A may match the phase of resonance of the second optical path P2 of FIG. 4B. In this way, in case that the length of the second optical path P2 of FIG. 4B is an integer multiple of the length of the first optical path P1 of FIG. 4A, the phase of resonance of the first optical path P1 of FIG. 4A may match the phase of resonance of the second optical path P2 of FIG. 4B.

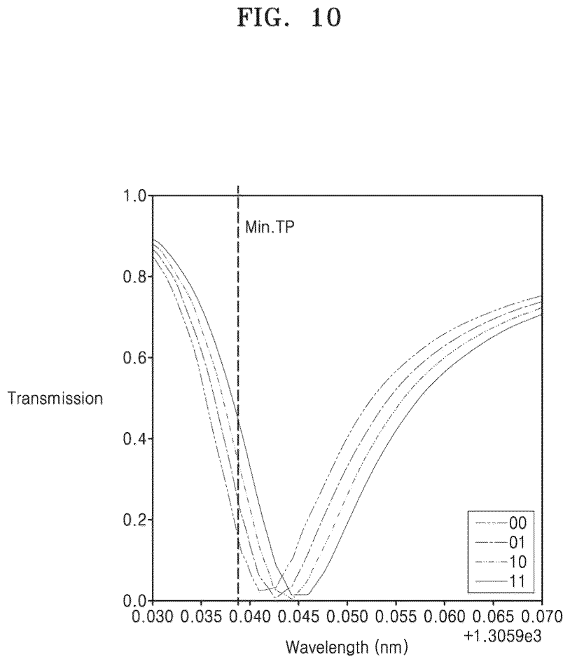

FIGS. 9 and 10 are graphs showing a transmissivity spectrum of an optical modulator according to one or more embodiments. FIG. 10 is a graph enlarging a box indicated by dotted lines of FIG. 9.

Referring to FIG. 9, a transmissivity spectrum having a dip arranged at specific intervals to a specific depth may be seen. The dip may be significant reduction of a transmissivity in a specific wavelength band, and a wavelength corresponding to each dip may be modulated.

Referring to FIG. 10, each line indicates four levels of 00, 01, 10, and 00 in 2-bit encoding. For example, 01 may be a state in which in the optical modulator of FIG. 1, a voltage is not applied to the first modulation unit 130 to which the digital signal corresponding to the MSB is input, and a voltage is applied to the second modulation unit 140 to which the digital signal corresponding to the LSB is input. For example, 10 may be a state in which in the optical modulator of FIG. 1, a voltage is applied to the first modulation unit 130 to which the digital signal corresponding to the MSB is input, and a voltage is not applied to the second modulation unit 140 to which the digital signal corresponding to the LSB is input. At a wavelength indicated by a vertical line of FIG. 10, a transmissivity interval between signal levels may be maintained constant.

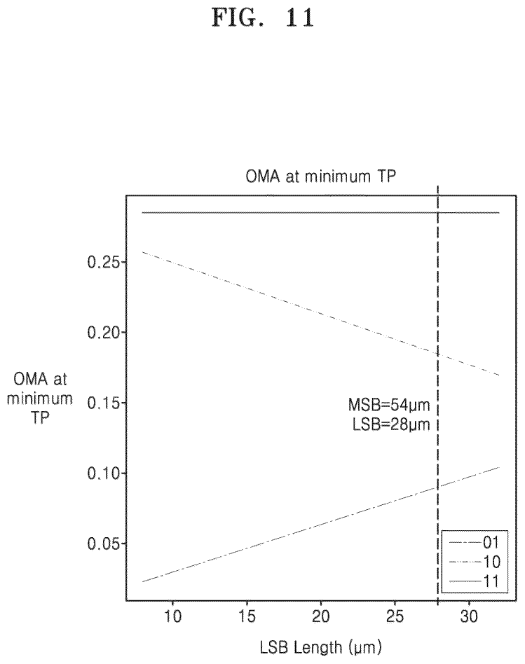

FIG. 11 is a graph showing an interval of a signal level with respect to a length of a first modulator (modulation unit) and a length of a second modulator (modulation unit).

Referring to FIG. 11, an x axis indicates a length of the second modulation unit 140 of FIG. 1 to which the digital signal corresponding to the LSB is input, and a y axis indicates an optical modulation amplitude (OMA). In case that the length of the second modulation unit 140 of FIG. 1 to which the digital signal corresponding to the LSB is input is 28 μm and the length of the first modulation unit 130 of FIG. 1 to which the digital signal corresponding to the MSB is input is 54 μm, there is a difference in optical modulation amplitude between signal levels at a wavelength indicated by a vertical line of FIG. 11. In this way, it may be seen that in case that the length of the second modulation unit 140 of FIG. 1 is about twice the length of the first modulation unit 130 of FIG. 1, an interval between signal levels is constant.

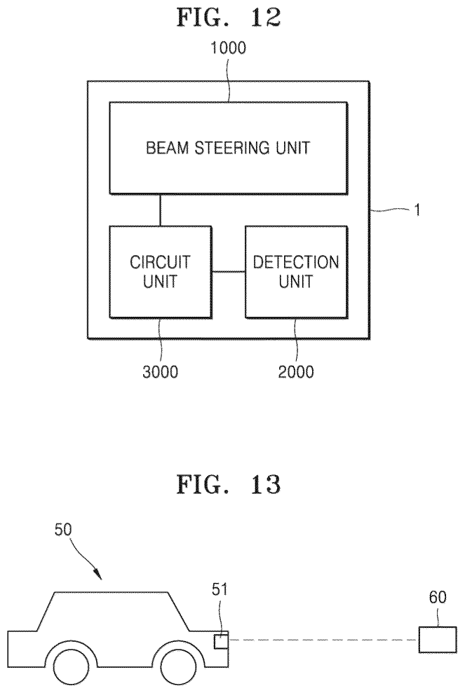

FIG. 12 is a block diagram of an optical device according to one or more embodiments.

Referring to FIG. 12, an optical device 1 may include a beam steering unit 1000. The beam steering unit 1000 may include the optical modulators 100, 101, 102, and 200 according to embodiments of FIGS. 1 and 5 to 7. The optical device 1 may include a detection unit 2000 to detect light steered by the beam steering unit 1000 and then reflected by a subject. The detection unit 2000 may include a plurality of optical detection elements and may further include other optical members. The optical device 1 may further include a circuit unit 3000 connected to at least one of the beam steering unit 1000 and the detection unit 2000. The circuit unit 3000 may include an operation unit that obtains data for an operation, and may further include a driving unit, a control unit, etc. The circuit unit 3000 may further include a power unit, a memory, etc.

While it is shown in FIG. 12 that the optical device 1 includes the beam steering unit 1000 and the detection unit 2000 in one device, the beam steering unit 1000 and the detection unit 2000 may also be separately provided in a separate device without being provided as one device. The circuit unit 3000 may be connected to the beam steering unit 1000 or the detection unit 2000 through wireless communication, instead of wiredly. A configuration of FIG. 12 may be changed variously.

The optical modulators 100, 101, 102, and 200 according to embodiments of FIGS. 1 and 5 to 7 may be applied to various optical devices. The optical modulators 100, 101, 102, and 200 may be applied to, for example, light detection and ranging (LiDAR) device. The LiDAR device may be of a phase-shift type or a time-of-flight (TOF) type. The LiDAR device may be applied to, for example, autonomous vehicles, flying objects such as drones, mobile devices, small walking devices (e.g., bicycles, motorcycles, baby strollers, boards, etc.), robots, human/animal assistance devices (e.g., canes, helmets, accessories, clothing, watches, bags, etc.), Internet of Things (IoT) devices/systems, security devices/systems, etc. The optical modulators 100, 101, 102, and 200 may be applied to, for example, transceiver devices. The optical modulators 100, 101, 102, and 200 may be applied to, for example, optical transmitters.

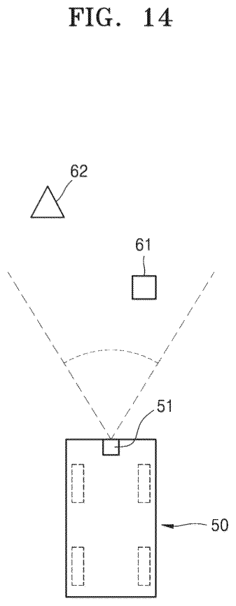

FIGS. 13 and 14 are conceptual views showing a vehicle including a LiDAR device according to one or more embodiments. FIG. 13 is a side view, and FIG. 14 is a plan view.

Referring to FIG. 13, a LiDAR device 51 may be applied to a vehicle 50, and information about a subject 60 may be obtained using the LiDAR device 51. The vehicle 50 may be a vehicle having an autonomous driving function. By using the LiDAR device 51, an object or a person, i.e., the subject 60 in a direction in which the vehicle 50 is moving may be detected. Moreover, a distance to the subject 60 may be measured using information such as a time difference between a transmission signal and a detected signal, etc. As shown in FIG. 14, information about a nearby subject 61 and a distant subject 62 in a scanning range may be obtained.

FIGS. 13 and 14 show an example in which the LiDAR device 51 is applied to a vehicle, but embodiments are not limited thereto. The LiDAR device 51 may be applied to, for example, autonomous vehicles, flying objects such as drones, mobile devices, small walking devices (e.g., bicycles, motorcycles, baby strollers, boards, etc.), robots, human/animal assistance devices (e.g., canes, helmets, accessories, clothing, watches, bags, etc.), Internet of Things (IoT) devices/systems, security devices/systems, etc.

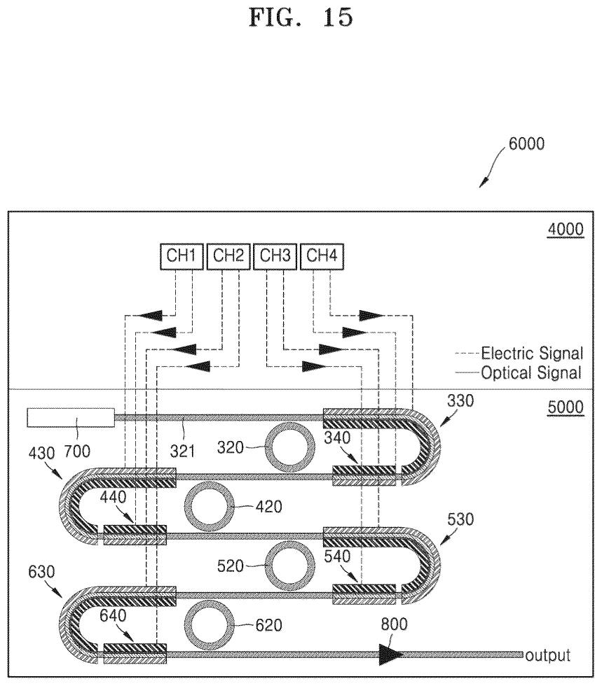

FIG. 15 shows an optical transmitter according to one or more embodiments.

Referring to FIG. 15, an optical transmitter 6000 may include an electronic integrated circuit 4000 and an optical integrated circuit 5000. The electronic integrated circuit 4000 may include a plurality of channels CH1, CH2, CH3, and CH4. The optical integrated circuit 5000 may include a plurality of first optical waveguides 320, 420, 520, and 620, the second optical waveguide 321, a plurality of first modulation units 330, 430, 530, and 630, a plurality of second modulation units 340, 440, 540, and 640, a light source 700, and an optical amplifier 800. The first optical waveguides 320, 420, 520, and 620, the second optical waveguide 321, the plurality of first modulation units 330, 430, 530, and 630, and the plurality of second modulation units 340, 440, 540, and 640 may be the same as the first optical waveguide 120, the second optical waveguide 121, the first modulation unit 130, and the fourth modulation unit 140 described with reference to FIG. 1. In a description of FIG. 5, a matter overlapping that of FIG. 1 will be omitted.

The optical transmitter 6000 may convert the electric signal into the optical signal and output the optical signal external to the optical transmitter 6000. The electric signal may be generated by the electronic integrated circuit 4000, supplied to the optical integration circuit 5000, and then converted into an optical signal in the optical integrated circuit 5000. The electric signal generated by the electronic integrated circuit 4000 may be input to the plurality of first modulation units 330, 430, 540, and 630, and the plurality of second modulation units 340, 440, 540, and 640 in the form of a voltage to generate an optical signal. By inputting the electric signal to the plurality of first modulation units 330, 430, 530, and 630 and the plurality of second modulation units 340, 440, 540, and 640 in a plurality of different channels CH1, CH2, CH3, and CH4, an optical signal may be generated.

The light source 700 may be, for example, a multi-wavelength laser light source. The optical amplifier 800 may be provided to improve the strength of the optical signal before outputting the optical signal.

With the optical modulator and the optical device including the optical modulator according to one or more embodiments, a modulator may be provided in a U-shape bus waveguide to reduce a manufacturing process difficulty of the optical modulator. While the optical modulator and the optical device including the optical modulator have been described with reference to the embodiments described in the drawings, it will be understood by those of ordinary skill in the art that various modifications and equivalent other embodiments are possible therefrom. Therefore, embodiments should be considered in a descriptive sense rather than a restrictive sense. The scope of the present specification is not described above, but in the claims, and all the differences in a range equivalent thereto should be interpreted as being included.

According to one or more embodiments, by providing a plurality of modulators in a U-shape bus waveguide, a digital electric signal may be converted into an analog optical signal without D/A conversion. In this way, power consumption of the optical modulator may be reduced.

According to one or more embodiments, by providing the modulation unit in the U-shape bus waveguide, the manufacturing process difficulty of the optical modulator may be reduced.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An optical modulator comprising:
a first optical waveguide having a ring shape; and
a second optical waveguide having a U shape extending adjacent to opposite sides of the first optical waveguide, the second optical waveguide comprising a first modulation unit and a second modulation unit,
wherein the first optical waveguide and the second optical waveguide are coupled to each other at a first coupling region and a second coupling region.

2. The optical modulator of claim 1, wherein a length of the first modulation unit is greater than a length of the second modulation unit.

3. The optical modulator of claim 1, wherein a length of the first modulation unit is twice a length of the second modulation unit.

4. The optical modulator of claim 1, wherein a length of a first optical path comprising an entirety of the first optical waveguide is an integer multiple of a wavelength of light to be modulated.

5. The optical modulator of claim 1, wherein a length of a second optical path is an integer multiple of a length of a first optical path,
wherein the first optical path comprises an entirety of the first optical waveguide, and
wherein the second optical path comprises a portion of the first optical waveguide extending from the first coupling region to the second coupling region, and a portion of the second optical waveguide extending from the portion of the first optical waveguide at the first coupling region to the portion of the first optical waveguide at the second coupling region.

6. The optical modulator of claim 1, wherein the first modulation unit comprises a first region and a second region which are respectively doped with opposite types of dopants.

7. The optical modulator of claim 6, wherein the first region is doped with an n-type dopant, and the second region is doped with a p-type dopant.

8. The optical modulator of claim 7, wherein a width of the first region is less than a width of the second region.

9. The optical modulator of claim 6, wherein the first modulation unit further comprises:
a third region doped at a concentration greater than a concentration of the first region; and
a fourth region doped at a concentration greater than a concentration of the second region.

10. The optical modulator of claim 9, wherein the third region is doped with an n-type dopant, and the fourth region is doped with a p-type dopant.

11. The optical modulator of claim 9, further comprising:
a first electrode on the third region; and
a second electrode on the fourth region.

12. The optical modulator of claim 11, wherein the first electrode is a cathode, and the second electrode is an anode.

13. The optical modulator of claim 1, further comprising a first heater on the first optical waveguide.

14. The optical modulator of claim 1, further comprising a second heater on the second optical waveguide.

15. The optical modulator of claim 1, wherein a distance between the first optical waveguide and the second optical waveguide in each of the first coupling region and the second coupling region is greater than or equal to 100 nm and less than or equal to 200 nm.

16. The optical modulator of claim 1, wherein a width of the second optical waveguide is greater than or equal to 100 nm and less than or equal to 500 nm.

17. An optical modulator comprising:
a substrate;
a first optical waveguide having a ring shape on the substrate; and
a second optical waveguide having a U shape extending adjacent to opposite sides of the first optical waveguide, the second optical waveguide comprising a first modulation unit, a second modulation unit, and a third modulation unit,
wherein the first optical waveguide and the second optical waveguide are coupled to each other at a first coupling region and a second coupling region.

18. The optical modulator of claim 17, wherein a length of a first optical path comprising an entirety of the first optical waveguide is an integer multiple of a wavelength of light to be modulated.

19. The optical modulator of claim 17, wherein a length of a second optical path is an integer multiple of a length of a first optical path,
wherein the first optical path comprises an entirety of the first optical waveguide, and
wherein the second optical path comprises a portion of the first optical waveguide extending from the first coupling region to the second coupling region, and a portion of the second optical waveguide extending from the portion of the first optical waveguide at the first coupling region to the portion of the first optical waveguide at the second coupling region.

20. An optical device comprising:
an optical modulator comprising:
a first optical waveguide having a ring shape; and
a second optical waveguide having a U shape extending adjacent to opposite sides of the first optical waveguide, the second optical waveguide comprising a first modulation unit and a second modulation unit,
wherein the first optical waveguide and the second optical waveguide are coupled to each other at a first coupling region and a second coupling region.
